(19) United States
(12) Patent Application Publication
(10) Pub. No.: US 2015/0225600 A1
(43) Pub. Date: Aug. 13, 2015

(54) GRAFTED ACRYLIC COMPRISING WATER SOLUBLE AND WATER INSOLUBLE PORTIONS AND LATTICES AND COATINGS COMPRISING THE SAME

(71) Applicant: PPG Industries Ohio, Inc., Cleveland, OH (US)

(72) Inventors: SARAH CUNNINGHAM, Amelia, OH (US); Youssef Moussa, Loveland, OH (US)

(73) Assignee: PPG Industries Ohio, Inc., Cleveland, OH (US)

(21) Appl. No.: 14/689,081

(22) Filed: Apr. 17, 2015

Related U.S. Application Data
(63) Continuation of application No. 13/117,270, filed on May 27, 2011.

(51) Int. Cl. C09D 151/00

(52) U.S. Cl. CPC C09D 151/003

(57) ABSTRACT

A latex comprising of two stage grafted acrylic is disclosed. The acrylic comprises a water soluble portion and a water insoluble portion that are grafted together. A method for making the latex, a coating comprising the latex, and substrates coated with the coating are also disclosed.

### CROSS-REFERENCE TO RELATED APPLICATION

This application is a continuation of application Ser. No. 13/117,270, filed May 27, 2011.

### FIELD OF THE INVENTION

The present invention relates to a two stage, grafted acrylic that comprises a wafer soluble portion and a water insoluble portion, wherein the portions are grafted together, and lattices and coatings comprising the same and methods for making the same.

### BACKGROUND INFORMATION

Acrylic lattices have been widely used in various industries in coatings for a wide range of metallic and non-metallic substrates. Certain coatings, particularly in the packaging industry, most undergo extreme stresses in the course of preparation and use of the packaging containers. In addition to flexibility, packaging coatings may also need resistance to chemicals, solvents, and pasteurization processes used in the packaging of beer and other beverages, and may also need to withstand retort conditions commonly employed is food packaging.

Bisphenol A (“BPA”) contributes to many of the properties desired in packaging coating products. The use of BPA and related products such as bisphenol A diglycidyl ether (“BADGE”), however, has recently come under scrutiny in the packaging industry. Substantially BPA-free coatings having properties comparable to coatings comprising BPA are therefore desired.

### SUMMARY OF THE INVENTION

The present invention is directed to a two stage, grafted acrylic that comprises a water soluble portion and a water insoluble portion, wherein one portion comprises alkoxy methyl (meth)acrylamide and the other portion comprises alkoxy methyl (meth)acrylamide reactive functionality comprising alkoxy, hydroxyl and/or amide functionality, and the portions are grafted together by reaction between the alkoxy methyl (meth)acrylamide and the alkoxy methyl (meth)acrylamide reactive functionality.

The present invention is further directed to a latex comprising such a two stage, grafted acrylic.

The present invention is further directed to a method for making such a latex comprising a) polymerizing the water insoluble portion in organic solvent; b) polymerizing the water soluble monomers in the presence of the product of step a; and c) inverting the product of step b into water; and d) polymerizing additional monomers in the presence of the product of step c.

The present invention is further directed to coatings comprising a two stage grafted acrylic and/or latex as described herein and substrates coated with the same.

### DETAILED DESCRIPTION OF THE INVENTION

The present invention is directed to a grafted acrylic that comprises a water soluble portion and a water insoluble portion. As used herein “water soluble” means a polymer chain containing monomers that can be dispersed into water, such as acidic monomers, and “water insoluble” means polymer chains lacking these monomers, such that the chain is not dispersible in water. One portion of the graft acrylic comprises alkoxy methyl (meth)acrylamide; the other portion comprises a compound having functionality that is reactive with alkoxy methyl (meth)acrylamide. Such a compound/functionality is sometimes referred to herein as “alkoxy methyl (meth)acrylamide reactive functionality.” The portions are grafted together by reaction between the alkoxy methyl (meth)acrylamide and the alkoxy methyl (meth)acrylamide reactive functionality.

Any suitable alkoxy methyl (meth)acrylamide can be used. For samples include N-butoxy methyl acrylamide (“NBMA”), isobutoxy methyl acrylamide, and ethoxy methyl acrylamide. Such alkoxy methyl (meth)acrylamides are available from Cytec and Mitsubishi. As used herein, and as is conventional in the art, the use of (meth) in conjunction with another word, such as acrylamide, refers to both the acrylamide and the corresponding methacrylamide. In certain embodiments, the alkoxy methyl (meth)acrylamide is in the water insoluble portion.

Similarly, any compound comprising alkoxy methyl (meth)acrylamide reactive functionality can be used. Such functionality includes alkoxy, hydroxyl and/or amide functionality. Thus, the present grafted acrylics are distinct from alkoxy methyl (meth)acrylamides reacted with carboxyl functionality. In certain embodiments, the alkoxy methyl (meth)acrylamide reactive functionality comprises hydroxyl functionality, such as a hydroxyl functional acrylate, such as 2-hydroxyethyl methacrylate (“HEMA”), hydroxy propyl acrylate, hydroxy butyl acrylates and the like. In other embodiments, the alkoxy methyl (meth)acrylamide reactive functionality comprises amide functionality, such as acrylamide functionality.

It will be appreciated by those skilled in the art that alkoxy methyl (meth)acrylamide will react with itself in a self condensation reaction. Thus, “alkoxy methyl (meth)acrylamide reactive functionality” also includes alkoxy functionality, such as alkoxy methyl (meth)acrylamide. Accordingly, in certain embodiments, each portion of the graft acrylic comprises alkoxy methyl (meth)acrylamide. When alkoxy methyl (meth)acrylamide is used in both portions the alkoxy methyl (meth)acrylamide used in one portion can be the same and/or different as that used in the other portion. In such embodiments, one or both portions can further comprise additional alkoxy methyl (meth)acrylamide reactive functionality.

The grafted acrylic of the present invention is a two stage grafted acrylic; that is, the acrylic is made in two stages. In certain embodiments, in a first stage the water insoluble monomers are polymerized in the presence of an initiator in organic solvent; an alkoxy methyl (meth)acrylamide can be included in the water insoluble portion. The water insoluble portion is polymerized by free radical polymerization using any initiator known in the art. The water soluble monomers are then polymerized in the presence of the polymerized water insoluble monomers. One or more of the water soluble monomers will typically comprise acid functionality to render the monomers water soluble. Such functionality can be, for example, in the form of (meth)acrylic acid and the like. The water soluble portion also includes either the alkoxy methyl (meth)acrylamide or the alkoxy methyl (meth)acrylamide reactive functionality, depending on which of these is in the water insoluble portion.

It will be appreciated that the acid functionality is introduced to impart water solubility to the monomers and not to react with the alkoxy methyl (meth)acrylamide, although such reaction may occur but only to a minor or insignificant degree. The mechanism for grafting the water soluble and water insoluble portions in the present invention is through a condensation reaction of the alkoxy group on the alkoxy methyl (meth)acrylamide and the alkoxy functionality, the hydroxy functionality, and/or the amide functionality. It will be appreciated that any reaction between the alkoxy methyl (meth)acrylamide and the acid functionality would not be more than in just minor amounts, and as a result, the acrylic would not be likely to form a stable latex. Thus, the acrylic of the present invention is distinct from other acrylics in which the reaction product is primarily alkoxy methyl (meth)acrylamide reacted with acid, i.e. carboxyl functionality in a free radical reaction.

Also present during the polymerization of the water soluble portion is a free radical initiator. As noted above, any suitable initiator can be used. It will be appreciated that grafting the water soluble portion in the presence of the water insoluble portion, or vice versa, where one portion comprises alkoxy methyl (meth)acrylamide and the other portion comprises alkoxy methyl (meth)acrylamide reactive functionality results in a grafted acrylic with two portions. It will be further appreciated that the alkoxy methyl (meth)acrylate and the alkoxy methyl (meth)acrylamide reactive functionality should be in different monomer charges; if both were introduced only in the water soluble portion or the water insoluble portion with neither in the other portion, the two portions would not graft, or at least would not graft by this mechanism. This grafted acrylic, because of its acid functionality, can be neutralized and dispersed into water. The inverted graft acrylic is suitable for use as a surfactant.

In a specific embodiment, both the water insoluble portion and the water soluble portion comprise NBMA, and in another specific embodiment the water insoluble portion comprises NBMA and the water soluble portion comprises HEMA.

One skilled in the art will appreciate that the acrylic of the present invention is a grafted acrylic comprising a water soluble acrylic polymer grafted to water insoluble acrylic polymer chains. The graft acrylic is essentially a dispersion of particles, with water soluble chains on the outside of the particles and water insoluble chains on the inside. The graft acrylic particles can have an average size of 0.01 to 1.0 micron, such as 0.05 to 0.5 micron, 0.1 to 0.5 micron or 0.1 to 0.2 micron. Any values within these broad ranges are also within the scope of the present invention.

The graft acrylic can have a weight average molecular weight (“Mw”) as measured by gel permeation chromatography in tetrahydrofuran of 10,000 to 100,000, such as 30,000 to 60,000 or 40,000 to 50,000. Any values between these broad ranges are also within the scope of the present invention. In a particular embodiment, the grafted acrylic has an Mw of 45,000-50,000 and in another particular embodiment, as Mw of 32,000 to 37,000.

The graft acrylic can have theoretical acid value of 15 to 200 mg KOH/gm, such as from 20 to 40 mg KOH/gm. Any values between these broad ranges are also within the scope of the present invention. In a particular embodiment, the grafted acrylic has a theoretical acid value of 24.0 mg KOH/gm±2.0 and in another particular embodiment a theoretical acid value of 30.0 mg KOH/gm±2.0.

In certain embodiments, the Tg of the graft acrylic is 0 to 100° C., such as 20° C. to 45° C. In a particular embodiment the Tg is 26° C.±2° C. and in another particular embodiment the Tg is 30° C.±2° C.

In general, two-stage acrylics can give some advantages over one-stage acrylics, such as higher solids, lower viscosity, and/or higher molecular weight. The two stage acrylic of the present invention will be understood as being different from a one stage acrylic in many notable respects. For example, in a one stage acrylic, the acrylic chains may be largely linear unless polyfunctional monomers are used, whereas in the present two stage process there is branching due to the water soluble polymer chains and the water insoluble polymer chains grafting together. Using a polyfunctional monomer in a one stage process, however, does not give the same control over the polymer architecture as the present invention. For example, one could not likely make the grafted acrylic of the present invention in one stage. The water soluble and water insoluble monomers would not be discrete portions as they are is the present invention. In addition, in a water soluble acrylic prepared in one stage, the acrylic will appear clear or almost clear after inversion into water. In contrast, the present acrylic, because of the presence of water insoluble portions, will appear cloudy or milky upon inversion into water. In addition, the present two stage grafted acrylic will likely have better solids viscosity as compared to an all water soluble, one stage counterpart; since part of the solids of the present graft acrylic are insoluble, they contribute to the molecular weight of the grafted acrylic, but not the viscosity. Thus, at the same solids content and molecular weight, the present grafted acrylic will have a lower viscosity. For example, the present two stage acrylics can have a theoretical solids content of 20 to 30%, while still having a viscosity that allows them to be useful in coatings compositions. The present grafted acrylic may also have a much lower acid content as compared to an all water soluble, one stage counterpart; this may allow a higher solids emulsion to be made using the present graft acrylic.

As noted above, the grafted acrylic of the present invention can be inverted in water to form a surfactant. A latex can then be made in the presence of this surfactant. This product is sometimes referred to herein as the “grafted acrylic latex”. A grafted acrylic latex can be formed for example, by polymerizing monomers in the presence of the grafted acrylic surfactant in the water phase. Any suitable monomers can be used, such as acrylic monomers that are known to those skilled in the art for forming an acrylic latex. Particularly suitable examples include alkyl (meth)acrylates, hydroxy functional (meth)acrylates, styrene, and the like. In certain embodiments, the latex monomer charge includes alkoxy methyl (meth)acrylamide, and may specifically comprise NBMA. In certain embodiments, the latex monomer charge comprises 5 weight percent or less acid functional monomers, such as 2 weight percent or less or 1 weight percent or less, with weight percent based on total solids weight. The polymerization can be performed in the presence of a suitable initiator, such as a water soluble initiator, to make a latex. A particularly suitable initiator is a peroxide initiator used alone or in conjunction with benzoin. Accordingly, the present invention is further directed to a latex comprising the grafted acrylic described above.

The average particle size of the grafted acrylic latex particles can be from 0.05 to 1.0 micron, such as 0.1 to 0.2 micron, or 0.1 to 0.5 micron. The Mw of these particles as measured by gel-permeation chromatography in tetrahydrofuran can be, for example, 50,000 to 1,000,000, such as 100,000 to 500,000 or 100,000 to 250,000. Any values within these broad ranges are also within the scope of the present invention. In a particular embodiment, the Mw is 125,000 to 140,000 and in another particular embodiment the Mw is 200,000 to 230,000. Theoretical Tg values for the grafted acrylic latex can be 10° to 100° C., such as 25° C. to 80° C.

The present invention is further directed to a coating comprising the grafted acrylic and/or the grafted acrylic latex described above. The coatings of the present invention can comprise, for example, 10 to 100 weight percent of the grafted acrylic and/or the grafted acrylic latex described above, such as 20 to 80 weight percent or 30 to 50 weight percent, with weight percent based on the total solid weight of the coating.

In certain embodiments, the grafted acrylic and/or grafted acrylic latex will function as the film forming resin in the coating. In such embodiments, the coating may further comprise a crosslinker. Suitable crosslinkers include benzoguanamine, phenolics and melamine aminoplasts, all of which are widely commercially available from S.I. or Cytec. In some embodiment, the alkoxy methyl (meth)acrylamide itself serves as a crosslinker either alone or in addition to other crosslinkers. In these embodiments, sufficient alkoxy methyl (meth)acrylamide and/or alkoxy methyl (meth)acrylamide reactive functionality should be used so as to allow for both grafting of the water soluble and insoluble portions of the acrylic and for crosslinking the coating.

It will be appreciated that the grafted acrylic and/or grafted acrylic latex of the present coatings (and crosslinker therefor if used) can form all or part of the film-forming resin of the coating. In certain embodiments, one or more additional film-forming resins are also used in the coating. For example, the coating compositions can comprise any of a variety of thermoplastic and/or thermosetting compositions known in the art.

Thermosetting or curable coating compositions typically comprise film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, polyepoxy polymers, epoxy resins, vinyl resins, copolymers thereof, and mixtures thereof. Generally, these polymers can be any polymers of these types made by any method known to those skilled in the art. Such polymers may be solvent-borne or water-dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof. Appropriate mixtures of film-forming resins may also be used in the preparation of the present coating compositions.

Thermosetting coating compositions typically comprise a crosslinking agent that may be selected from any of the crosslinkers described above or known in the art to react with the functionality used in the coating. In certain embodiments, the present coatings comprise a thermosetting film-forming polymer or resin and a crosslinking agent therefor and the crosslinker is either the same or different from the crosslinker that is used to crosslink the grafted acrylic and/or grafted acrylic latex. In certain other embodiments, a thermosetting film-forming polymer or resin having functional groups that are reactive with themselves are used; in this manner, such thermosetting coatings are self-crosslinking.

In one embodiment, the coating comprises a higher Tg grafted acrylic latex, that is a grafted acrylic latex having a Tg of 60° C. to 90° C., and a phenolic crosslinker. Use of such a grafted acrylic latex, alone or in conjunction with another acrylic component, allows the amount of phenolic crosslinker to be significantly lower. In one embodiment, the addition of the grafted acrylic latex of the Tg range specified above allowed the phenolic to be reduced from 70 weight percent to 30 weight percent of the coating composition, based on total solids weight, while still maintaining performance requirements. The phenolic reduction also led to a lower cost for the coating composition, better flexibility, and decreased blistering during oven cure. Accordingly, in another embodiment, the coating comprises a grafted acrylic latex and a phenolic crosslinker, wherein the crosslinker comprises 50 weight percent or less of the total solids of the composition, such as 40 weight percent or less, 35 weight percent or less, or 30 weight percent or less.

If desired, the coating compositions can comprise other optional materials well known in the art of formulating coatings in any of the components, such as colorants, plasticizers, abrasion-resistant particles, antioxidants, hindered amine light stabilizers, UV light absorbers and stabilizers, surfactants, flow control, agents, thixotropic agents, fillers, organic cosolvents, reactive diluents, catalysts, grind vehicles, and other customary auxiliaries.

As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent- and/or aqueous-based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water-miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application Ser. No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004, and incorporated herein by reference.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles, having an average particle size of 0.1 to 50, 0.1 to 20, 1 to 12, 1 to 10, or 3 to 6 microns, or any combination within any of these ranges. The particles can be nanoparticles, having an average particle size of less than 0.1 micron, such as 0.8 to 500, 10 to 100, or 100 to 500 nanometers, or any combination within these ranges.

In certain embodiments, the graft acrylic, grafted acrylic latex and/or coating comprising the same may be substantially free, may be essentially free and/or may be completely free of bisphenol A and derivatives or residues thereof, including bisphenol A and bisphenol A diglycidyl ether (“BADGE”). A graft acrylic, grafted acrylic latex and/or coating that is substantially bisphenol A free is sometimes referred to as “BPA non intent” because BPA, including derivatives or residues thereof, are not intentionally added but may be present in trace amounts such as because of impurities or unavoidable contamination from the environment. The graft acrylic, grafted acrylic latex and/or coatings of the present invention can also be substantially free, essentially free and/or completely free of bisphenol F and derivatives or residues thereof, including bisphenol F and bisphenol F diglycidyl ether (“BPFDG”). The term “substantially free” as used in this context means the graft acrylic, grafted acrylic latex and/or coating compositions contain less than 1000 parts per million (ppm), “essentially free” means less man 100 ppm and “completely free” means less than 20 parts per billion (ppb) of any of the above compounds or derivatives or residues thereof.

The present coatings can be applied to any substrates, for example, automotive substrates, industrial substrates, packaging substrates, wood flooring and furniture, apparel, electronics including housings and circuit boards, glass and transparencies, sports equipment including golf balls, and the like. These substrates can be, for example, metallic or non-metallic. Metallic substrates include tin, steel, tin-plated steel, chromium passivated steel, galvanized steel, aluminum, aluminum foil, coiled steel or other coiled metal. Non-metallic substrates including polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather, both synthetic and natural, and the like. The substrate can be one that has been already treated in some manner, such as to impart visual and/or color effect

The coatings of the present invention can be applied by any means standard in the art, such as electrocoating, spraying, electrostatic spraying, dipping, rolling, brushing, roller coating, flow coating, extrusion and the like.

The coatings can be applied to a dry film thickness of 0.04 mils to 4 mils, such as 0.1 to 2 or 0.7 to 1.3 mils. In other embodiments, the coatings can be applied to a dry film thickness of 0.1 mils or greater, 0.5 mils or greater, 1.0 mils or greater, 2.0 mils or greater, 5.0 mils or greater, or even thicker. The coatings of the present invention can be used alone, or in combination with one or more other coatings. For example, the coatings of the present invention can comprise a colorant or not and can be used as a primer, basecoat, and/or top coat. For substrates coated with multiple coatings, one or more of those coatings can be coatings as described herein.

It will be appreciated that the coatings described herein can be either one component (“1K”), or multi-component compositions such as two component (“2K”) or more. A 1K composition will be understood as referring to a composition wherein all the coating components are maintained in the same container alter manufacture, during storage, etc. A 1K coating can be applied to a substrate and cured by any conventional means, such as by heating, forced air, radiation cure and the like. The present coatings can also be multi-component coatings, which will be understood as coatings in which various components are maintained separately until just prior to application. As noted above, the present coatings can be thermoplastic or thermosetting.

In certain embodiments, the coating is a clearcoat. A clearcoat will be understood as a coating that is substantially transparent. A clearcoat can therefore have some degree of color, provided it does not make the clearcoat opaque or otherwise affect, to any significant degree, the ability to see the underlying substrate. The clearcoats of the present invention can be used, for example, in conjunction with a pigmented basecoat. The clearcoat can be modified by reaction with carbamate.

In certain other embodiments, the coating is a basecoat. A basecoat is typically pigmented; that is, it will impart some sort of color and/or other visual effect to the substrate to which it is applied.

The coating compositions of the present invention can be applied alone or as part of a coating system that can be deposited onto the different substrates that are described herein. Such a coating system typically comprises a number of coating layers, such as two or more. A coating layer is typically formed when a coaling composition that is deposited onto the substrate is substantially cured by methods known in the art (e.g., by thermal heating). The coating compositions described above can be used in one or more of the coating layers described herein.

In a conventional coating system used in the automotive industry, a preheated substrate is coated with an electrodepositable coating composition. After the electrodepositable coating composition is cured, a primer-surfacer coating composition is applied onto a least a portion of the electrodepositable coating composition. The primer-surfacer coating composition is typically applied to the electrodepositable coating layer and cured prior to a subsequent coating composition being applied over the primer-surfacer coating composition. However, in some embodiments, the substrate is not coated with an electrodepositable coating composition. Accordingly, in these embodiments, the primer-surfacer coating composition is applied directly onto the substrate. In other embodiments, the primer-surfacer coating composition is not used in the coating system. Therefore, a color imparting basecoat coating composition can be applied directly onto the cured electrodepositable coating composition.

In certain embodiments, a clearcoat is deposited onto at least a portion of the basecoat coating layer. In certain embodiments, the substantially clear coating composition can comprise a colorant but not in an amount such as to render the clear coating composition opaque (not substantially transparent) after it has been cured. In certain instances, the BYK Haze value of the cured composition is less than 50, can be less than 35, and is often less than 20 as measured using a BYK Haze Gloss meter available from BYK Chernie USA.

The coating composition of the present invention can be used in either the basecoat and/or clearcoat described above.

In certain embodiments, the coatings of the present invention may be used in a monocoat coating system. In a monocoat coating system, a single coating layer is applied over a substrate (which can be pretreated or non-pretreated) that can comprise one or more of the following layers (as described above): an electrodepositable coating layer or a primer-surfacer coating layer. In certain embodiments, the coating composition of the present invention is used in a monocoat coating system.

The coatings of the present invention are particularly suitable for use as a packaging coaling. The application of various pretreatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans. Certain coatings of the present invention are particularly applicable for use with coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to cracking, popping, corrosion, blushing and/or blistering.

Accordingly, the present invention is further directed to a package coated at least in part with any of the coating compositions described above. A “package” is anything used to contain another item. It can be made of metal or non-metal, for example, plastic or laminate, and be in any form. In certain embodiments, the package is a laminate tube. In certain embodiments, the package is a metal can. The term “metal can” includes any type of metal can, container or any type of receptacle or portion thereof used to hold something. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends”, which are typically stamped from can end stock arid used in conjunction with the packaging of beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two-piece cans” and “three-piece cans” as well as drawn and ironed one-piece cans; such one-piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating can be applied to the interior and/or the exterior of the package. For example, the coating can be rollcoated onto metal used to make a two-piece food can, a three-piece food can, can end stock and/or cap/closure stock. In some embodiments, the coating is applied to a coil or sheet by roll coating; the coating is then cured by heating or radiation and can ends are stamped out and fabricated into the finished product i.e. can ends. In other embodiments, the coating is applied as a rim coat to the bottom of the can; such application can be by roll coating. The rim coat functions to reduce friction for improved handling during the continued fabrication and/or processing of the can. In certain embodiments, the coating is applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

The packages of the present invention can be coated with any of the compositions described above by any means known in the art, such as spraying, roll coating, dipping, flow coating and the like; the coating may also be applied by electrocoating when the substrate is conductive. The appropriate means of application can be determined by one skilled in the art based upon the type of package being coated and the type of function for which the coating is being used. The coatings described above can be applied over the substrate as a single layer or as multiple layers with multiple heating stages between the application of each layer, if desired. After application to the substrate, the coating composition may be cured by any appropriate means.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. Singular encompasses plural and vice versa. For example, although reference is made herein to “a” grafted acrylic latex, “a” water soluble portion, “a” water insoluble portion, “a” grafted acrylic, one or more of each of these and any other components can be used. As used herein, the term “polymer” refers to oligomers and both homopolymers and copolymers, and the prefix “poly” refers to two or more. “Including,” “for example,” “such as” and like terms means including, for example, such as, but not limited to. When ranges are given, any endpoints of those ranges and/or numbers within those ranges can be combined with the scope of the present invention.

### EXAMPLES

The following examples are intended to illustrate the invention and should not be construed as limiting the invention in any way.

### Example 1: NBMA-Functional Latex

### Preparation of NBMA-Grafted Acrylic

The following solvents were added to a 5 liter glass flask: 195.76 g butyl cellosolve, 92.51 g isopropanol, and 30.14 g deionized water. Under agitation and a nitrogen blanket, the flask was heated to reflux (195° F.). Once refluxing, group A monomers as indicated in Table 1 and 26.72% of the initiator mixture were added to the flask over 60 minutes. When the first monomer addition was complete, the flask was held at reflux for 30 minutes. Then, group B monomers and 62.10% of the initiator mixture were added to the flask over 120 minutes. When the second monomer addition was complete, the flask was held at reflux for 15 minutes. The reflux temperature increased throughout the two monomer additions to 210-215° F. The remaining 11.19% of the initiator mixture was added to the flask along with a rinse of 27.72 g of deionized water and the mixture was held for 60 minutes at reflux. Following the hour hold, the resin was cooled to 170° F. At 170° F., 80.21 g of dimethyl ethanolamine (50% neutralized) was added dropwise with an addition funnel. After neutralizing, 2657.44 g of deionized water was added to the resin over 45-60 minutes to disperse into water. After the water addition, the resin was cooled to room temperature and filtered through a 25 μm filter bag.

TABLE 1

| | | Amount |
|---|---|---|
| | Components | (g) |
| Group A Monomers | N-butoxymethylacrylamide | 82.72 |
| | (52% active) | |
| | Styrene | 146.58 |
| | Ethyl Acrylate | 240.13 |
| Group B Monomers | Methacrylic Acid | 155.02 |
| | N-butoxymethylacrylamide | 87.40 |
| | (52% active) | |
| | Styrene | 38.69 |
| | Ethyl Acrylate | 299.97 |
| Initiator Mixture | T-butyl Peroctoate | 43.27 |
| | Butyl Cellosolve | 39.15 |

### Preparation of NBMA-Functional Acrylic Latex

The following components were added to a 3 liter glass flask: 940.42 g of NBMA-grafted acrylic (prepared above), 17.89 g dimethyl ethanolamine, and 10.04 g deionized water. Under agitation and a nitrogen blanket, the mixture was heated to 190° F. A mixture of 2.88 g benzoin, 2.82 g butyl cellosolve, and 17.76 g deionized water was added to the flask and the flask was held for 15 minutes. After the 15 minute hold, a mixture of 2.88 g hydrogen peroxide (35% active) and 1.86 g deionized water was added to the flask and the flask was held for 5 minutes. After the hold, a mixture of 2.26 g methacrylic acid, 30.38 g N-butoxymethylacrylamide (52% active), 92.92 g styrene, and 114.71 g ethyl acrylate was added to the flask over 90 minutes. After the monomer addition was complete, a rinse of 15.90 g of deionized water was added and the batch was held for 15 minutes. Then, four chasers were added to the flask (see Table 2) with a 60 minute hold following each chaser. Following the fourth chaser hold, the batch was cooled to room temperature and filtered through a 10 μm filter bag.

TABLE 2

| | Component | Amount (g) |
|---|---|---|
| Chaser #1 | Benzoin | 2.18 |
| | Butyl Cellosolve | 1.09 |
| | Hydrogen Peroxide (35% active) | 2.18 |
| | Deionized Water | 1.86 |
| Chaser # 2 | Benzoin | 2.18 |
| | Butyl Cellosolve | 1.09 |
| | Hydrogen Peroxide (35% active) | 2.18 |
| | Deionized Water | 1.86 |
| Chaser #3 | T-butyl Peroctoate | 4.52 |
| | Deionized Water | 1.86 |
| Chaser #4 | T-butyl Peroctoate | 4.52 |
| | Deionized Water | 1.86 |

Some of the physical properties of the grafted acrylic and grafted acrylic latex are summarized below in Table 3:

TABLE 3

| | | | High | | | MEK |
|---|---|---|---|---|---|---|
| | Tg¹ | ASTM | Bake | | Average | Rubs |
| | (theo- | % | % | Vis- | Particle | 400° F., |
| | retical) | TNV² | TNV³ | cosity⁴ | Size⁵ | 60 sec⁶ |
| Graft | 26° C. | 24.69% | 22.48% | 230 cP | 0.115 μm | 20-25 |
| Acrylic | | | | | | |
| Latex | 25° C. | 36.79% | 33.25% | 460 cP | 0.130 μm | 2 |

¹Glass Transition Temperature
²American Society for Testing and Material (ASTM) Total Non-volatile Solids determined at: 60 minutes, 230° F., 57 mm pan, 0.5 g sample, 1 g dilutant
³High Bake Solids determined at: 10 minutes, 400° F., 70 mm pan, 0.5 g sample, 1 g dilutant
⁴Brookfield Viscosity measured with a #3 spindle
⁵Average Particle Size measured with a Laser Diffraction Particle Size Analyzer
⁶Solvent resistance test method where a one pound hammer covered with a methyl ethyl ketone soaked gauze was double rubbed across a cured resin. The resin was drawn down on an aluminum panel and baked in a box oven for 60 seconds at 400° F.

To make a substantially BPA free exterior beverage coating, the following formulation was made by mixing the latex described above and the other components show in Table 4:

TABLE 4

| Component | Amount (g) |
|---|---|
| NBMA-func. Acrylic Latex | 524.32 |
| Hexamethoxymethylmelamine⁷ | 9.43 |
| DDBSA Catalyst | 2.00 |
| Butyl Cellosolve | 140.13 |
| MICROSPERSION 523⁸ | 2.17 |
| LUBA-PRINT 254⁹ | 16.35 |
| Deionzied Water | 140.13 |

⁷Obtained from Cytec
⁸Obtained from Micro Powders
⁹Obtained from L. P. Bader & Co.

When drawn down using a draw down baron an aluminum panel and baked in a 485° F. coil oven for 10 sec to a dry film thickness of about 1.5 mg/in², a substantially bisphenol free exterior beverage coating made with the NBMA-functional acrylic latex described above exhibited good blush resistance and adhesion in water retort (265° F., 90 minutes), 1% Joy solution (180° F., 10 minutes) and 0.165% Dowfax solution (boiling solution, 15 minutes). It also showed good wax mobility, application, and fabrication.

### Example 2

A comparative example was run in which an acrylic was made using alkoxy methyl (meth)acrylamide, but not alkoxy methyl (meth)acrylamide reactive functionality. More specifically, an acrylic was made using the procedure as generally outlined in Example 1 only without NBMA in Group A (example 2A) or in Group B (example 2B).

### Example 2A

The following solvents were added to a 3 liter glass flask: 103.11 g butyl cellosolve, 48.72 g isopropanol, and 15.88 g deionized water. Under agitation and a nitrogen blanket, the flask was heated to reflux (195° F.). Once refluxing, group A monomers show in Table 5 and 26.72% of the initiator mixture were added to the flask over 60 minutes. When the first monomer addition was complete, the flask was held at reflux for 30 minutes. Then, group B monomers and 62.10% of the initiator mixture were added to the flask over 120 minutes. When the second monomer addition was complete, the flask was held at reflux for 15 minutes. The reflux temperature increased throughout the two monomer additions to 210-215° F. The remaining 11.19% of the initiator mixture was added to the flask along with a rinse of 14.60 g of deionized water and the mixture was held for 60 minutes at reflux. Following the hour hold, the resin was cooled to 170° F. At 170° F., 42.25 g of dimethyl ethanolamine was added drop wise with an addition funnel. After neutralizing, 1399.66 g of deionized water was added to the resin over 45-60 minutes to disperse into water. After the water addition, the resin was cooled to room temperature and filtered through a 25 μm filter bag.

TABLE 5

| | Components | Amount (g) |
|---|---|---|
| Group A Monomers | Styrene | 97.75 |
| | Ethyl Acrylate | 128.59 |
| Group B Monomers | Methacrylic Acid | 81.65 |
| | N-butoxymethylacrylamide | 46.03 |
| | (52% active) | |
| | Styrene | 20.38 |
| | Ethyl Acrylate | 157.99 |
| Initiator Mixture | T-butyl Peroctoate | 22.79 |
| | Butyl Cellosolve | 20.62 |

Physical properties of the acrylic surfactant with NBMA removed from group A monomers:

| | | High Bake | |
|---|---|---|---|
| | Theo. Tg | % TNV | Particle Size |
| Acrylic | 26° C. | 22.93% | 0.180 μm |

The acrylic made above with NBMA removed from group A monomers showed a higher particle size of 0.180 μm and had a bimodal distribution compared to the graft acrylic made in Example 1, which had a particle size of 0.115 μm and a unimodal distribution. The larger particle size with a bimodal distribution indicates instability, perhaps due to a lack of grafting between group A and group B monomers.

### Example 2B

The following solvents were added to a 3 liter glass flask: 103.16 g butyl cellosolve, 48.75 g isopropanol, and 15.88 g deionized water. Under agitation and a nitrogen blanket, the flask was heated to reflux (195° F.). Once refluxing, group A monomers shown in Table 6 and 26.72% of the initiator mixture were added to the flask over 60 minutes. When the first monomer addition was complete, the flask was held at reflux for 30 minutes. Then, group B monomers and 62.10% of the initiator mixture were added to the flask over 120 minutes. When the second monomer addition was complete, the flask was held at reflux for 15 minutes. The reflux temperature increased throughout the two monomer additions to 210-215° F. The remaining 11.19% of the initiator mixture was added to the flask along with a rinse of 14.60 g of deionized water and the mixture was held for 60 minutes at reflux. Following the hour hold, the resin was cooled to 170° F. At 170° F., 42.27 g of dimethyl ethanolamine was added drop wise with an addition funnel. After neutralizing, 1400.40 g of deionized water was added to the resin over 45-60 minutes to disperse into water. After the water addition, the resin was cooled to room temperature and filtered through a 25 μm filter bag.

TABLE 6

| | Components | Amount (g) |
|---|---|---|
| Group A | N-butoxymethylacrylamide (52% active) | 43.59 |
| Monomers | Styrene | 77.24 |
| | Ethyl Acrylate | 126.54 |
| Group B | Methacrylic Acid | 81.69 |
| Monomers | Styrene | 41.18 |
| | Ethyl Acrylate | 161.24 |
| Initiator | T-butyl peroctoate | 22.80 |
| Mixture | Butyl Cellosolve | 20.63 |

Some of the physical properties of the acrylic surfactant are summarized below:

| | | High Bake | | MEK Rubs |
|---|---|---|---|---|
| | Theo. Tg | % TNV | Particle Size | 400° F., 60 sec |
| Acrylic | 26° C. | 22.91% | 0.115 μm | 3 |

The acrylic made above with NBMA removed from group B monomers exhibited a particle size and distribution similar to the grafted acrylic from Example 1 (mean particle size of 0.115 μm, unimodal distribution). However, the Example 2B acrylic had significantly lower NBMA MEK rubs compared to the Example 1 surfactant, decreasing from 20-25 rubs to 3 rubs. (The resins were drawn down over aluminum and baked for 1 minute at 400° F. to test MEK resistance.) This indicates that using an alkoxy methyl (meth)acrylamide and an alkoxy methyl (meth)acrylamide reactive functionality in the monomer additions according to the present invention yields an acrylic with better cure properties as compared to an acrylic having alkoxy methyl (meth)acrylamide in only one monomer group, with no alkoxy methyl (meth)acrylamide functionality in the other.

### Example 3: NBMA-Functional Latex

### Preparation of NBMA-Grafted Acrylic

The following solvents were added to a 5 liter glass flask: 245.76 g butyl cellosolve, 92.51 g isopropanol, and 30.14 g deionized water. Under agitation and a nitrogen blanket the flask was heated to reflux (195° F.). Once refluxing, group A monomers, shown in Table 7, and 26.72% of the initiator mixture were added to the flask over 60 minutes. When the first monomer addition was complete, the flask was held at reflux for 30 minutes. Then, group B monomers and 62.10% of the initiator mixture were added to the flask over 120 minutes. When the second monomer addition was complete, the flask was held at reflux for 15 minutes. The reflux temperature increased throughout the two monomer additions to 210-215° F. The remaining 11.19% of the initiator mixture was added to the flask along with a rinse of 27.72 g of deionized water and the mixture was held for 60 minutes at reflux. Following the hour hold, the resin was cooled to 170° F. At 170° F., 100.26 g of dimethyl ethanolamine (50% neutralized) was added dropwise with an addition funnel. After neutralizing, 2587.80 g of deionized water was added to the resin over 45-60 minutes to disperse into water. After the water addition, the resin was cooled to room temperature and filtered through a 25 μm filter bag.

TABLE 7

| | Components | Amount (g) |
|---|---|---|
| Group A | N-butoxymethylacrylamide (52% active) | 82.72 |
| Monomers | Styrene | 142.83 |
| | Ethyl Acrylate | 243.88 |
| Group B | Methacrylic Acid | 193.77 |
| Monomers | N-butoxymethylacrylamide (52% active) | 87.40 |
| | Styrene | 18.69 |
| | Ethyl Acrylate | 281.22 |
| Initiator | T-butyl peroctoate | 43.27 |
| Mixture | Butyl Cellosolve | 39.15 |

### Preparation of NBMA-Functional Acrylic Latex

The following components were added to a 3 liter glass flask: 1880.84 g of NBMA-grafted surfactant acrylic (prepared above), 44.72 g dimethyl ethanolamine, and 97.00 g deionized water. Under agitation and a nitrogen blanket, the mixture was heated to 190° F. 5.76 g of benzoin was added to the flask and the flask was held for 15 minutes. After the 15 minute hold, 5.76 g hydrogen peroxide (35% active) was added to the flask and the flask was held for 5 minutes. After the hold, a mixture of 4.52 g methacrylic acid, 60.76 g N-butoxymethyl acrylamide (52% active), 365.84 g styrene, and 49.42 g ethyl acrylate were added to the flask over 90 minutes. After the monomer addition was complete, a rinse of 10.00 g butyl cellosolve was added and the batch was held for 15 minutes. Then, four chasers were added to the flask (see Table 8 below) with a 60 minute hold following each chaser. Following the fourth chaser hold, the batch was cooled to room temperature and filtered through a 25 μm filter bag.

TABLE 8

| | Component | Amount (g) |
|---|---|---|
| Chaser #1 | Benzoin | 2.18 |
| | Hydrogen Peroxide (35% active) | 2.18 |
| Chaser # 2 | Benzoin | 2.18 |
| | Hydrogen Peroxide (35% active) | 2.18 |
| Chaser #3 | T-butyl Peroctoate | 4.52 |
| Chaser #4 | T-butyl Peroctoate | 4.52 |

Some of the physical properties of the grafted acrylic and grafted acrylic latex are summarized below:

| | | ASTM | High Bake | | |
|---|---|---|---|---|---|
| | Theo. Tg | % TNV | % TNV | Viscosity | Particle Size |
| Acrylic | 30° C. | 25.32% | 22.33% | 165 cP | 0.120 μm |
| Surfactant | | | | | |
| Latex | 80° C. | 37.52% | 33.29% | 310 cP | 0.135 μm |

This example illustrates forming a higher Tg latex. When this latex was used as a component of substantially BPA free food inside spray coating in an amount of about 40 weight percent, based on total solids weight of the coating, the coating had reduced blistering, improved flexibility, and allowed the level of phenolic to be reduced as compared to a similar coating that lacked the latex.

### Example 4: HEMA-Functional Latex

### Preparation of NBMA-Grafted Acrylic

The following solvents were added to a 5 liter glass flask: 195.76 g butyl cellosolve, 92.51 g isopropanol, and 30.14 g deionized water. Under agitation and a nitrogen blanket, the flask was heated to reflux (195° F.). Once refluxing, group A monomers and 26.72% of the initiator mixture were added to the flask over 60 minutes. When the first monomer addition was complete, the flask was held at reflux for 30 minutes. Then, group B monomers and 62.10% of the initiator mixture were added to the flask over 120 minutes. When the second monomer addition was complete, the flask was held at reflux for 15 minutes. The reflux temperature increased throughout the two monomer additions to 210-215° F. The remaining 11.19% of the initiator mixture was added to the flask along with a rinse of 27.72 g of deionized water and the mixture was held for 60 minutes at reflux. Following the hour hold, the resin was cooled to 170° F. At 170° F., 66.23 g of dimethyl ethanolamine (50% neutralized) was added dropwise with an addition funnel. After neutralizing, 2638.00 g of deionized water was added to the resin over 45-60 minutes to disperse into water. After the water addition, the resin was cooled to room temperature and filtered through a 25 μm filter bag.

| | Components | Amount (g) |
|---|---|---|
| Group A | N-butoxymethylacrylamide (52% active) | 82.72 |
| Monomers | Styrene | 146.58 |
| | Ethyl Acrylate | 240.13 |
| Group B | Methacrylic Acid | 127.99 |
| Monomers | N-butoxymethylacrylamide (52% active) | 87.40 |
| | Styrene | 65.72 |
| | Ethyl Acrylate | 299.97 |
| Initiator | T-butyl Peroctoate | 43.27 |
| Mixture | Butyl Cellosolve | 39.15 |

### Preparation of HEMA-Functional Acrylic Latex

The following components were added to a 3 liter glass flask: 932.86 g of NBMA-grafted surfactant acrylic (prepared above), 14.77 g dimethyl ethanolamine, and 78.50 g deionized water. Under agitation and a nitrogen blanket, the mixture was heated to 190° F. 2.88 g of benzoin was added to the flask and the flask was held for 15 minutes. Alter the 15 minute hold, 2.88 g of hydrogen peroxide (35% active) was added to the flask and the flask was held for 5 minutes. After the hold, a mixture of 2.26 g methacrylic acid, 15.80 g hydroxyethyl methacrylate, 128.92 g styrene, and 78.71 g butyl acrylate was added to the flask over 90 minutes. After the monomer addition was complete, a rinse of 5.00 g of butyl cellosolve was added and the batch was held for 15 minutes. Then, four chasers were added to the flask (see chart below) with a 60 minute hold following each chaser. Following the fourth chaser hold, the batch was cooled to room temperature and filtered through a 10 μm filter bag.

| | Component | Amount (g) |
|---|---|---|
| Chaser #1 | Benzoin | 1.09 |
| | Hydrogen Peroxide (35% active) | 1.09 |
| Chaser # 2 | Benzoin | 1.09 |
| | Hydrogen Peroxide (35% active) | 1.09 |
| Chaser #3 | T-butyl Peroctoate | 2.26 |
| Chaser #4 | T-butyl Peroctoate | 2.26 |

Some of the physical properties of the acrylic surfactant and latex are summarized below:

| | | ASTM | High Bake | | Particle |
|---|---|---|---|---|---|
| | Theo. Tg | % TNV | % TNV | Viscosity | Size |
| Acrylic | 25° C. | 24.41% | 22.50% | 152 cP | 0.100 μm |
| Surfactant | | | | | |
| Latex | 25° C. | 36.25% | 33.77% | 660 cP | 0.127 μm |

This HEMA-functional latex made with an NBMA-grafted acrylic, when incorporated into a coating substantially free of bisphenol, at about 90 weight percent, based on total solids weight of the coating, had performance similar to the coating comprising the latex in Example 1.

Whereas particular embodiments of this invention have been described above for purposes of illustration, it will be evident to those skilled in the art that numerous variations of the details of the present invention may be made without departing from the invention as defined in the appended claims.

1. A-grafted (meth)acrylic copolymer dispersion formed by
(a) polymerizing a mixture of monomers including a (meth)acrylic acid monomer and a polymerizable monomer containing N-alkoxymethyl amide groups or a polymerizable monomer containing different functional groups that are reactive with N-alkoxymethyl amide groups in organic solvent in the presence of
(i) a (meth)acrylic copolymer that is insoluble in water and which contains N-alkoxymethyl amide groups or different functional groups that are reactive with N-alkoxymethyl amide groups wherein either or both the mixture of monomers in (a) and/or the (meth)acrylic copolymer of (i) contains N-alkoxymethyl groups that are reactive with each other or with the different functional groups to form an acid group-containing grafted (meth)acrylic copolymer,
(b) neutralizing the acid group-containing grafted (meth)acrylic copolymer, and
(c) dispersing the neutralized copolymer of(b) in water.

2. The (meth)acrylic copolymer dispersion of claim 1, wherein the different functional groups comprise hydroxyl, and/or amide.

3. The (meth)acrylic copolymer dispersion of claim 2, wherein the hydroxyl functional groups are derived from 2-hydroxy ethyl methacrylate.

4. The (meth)acrylic copolymer dispersion of claim 1, wherein the N-alkoxymethyl amide groups are derived from N-butoxymethyl acrylamide.

5. The (meth)acrylic copolymer dispersion of claim 1, wherein the N-alkoxymethyl amide groups are present in the mixture of monomers in (a) and in the (meth)acrylic copolymer of (i).

6. The (meth)acrylic copolymer dispersion of claim 5, wherein the N-alkoxymethyl amide groups are derived from N-butoxymethyl acrylamide.

7. A (meth)acrylic polymer latex prepared by polymerizing a mixture of polymerizable monomers in the presence of the (meth)acrylic copolymer dispersion of claim 1.

8. A method for making the latex of claim 7, comprising:
a. polymerizing a mixture of monomers including a (meth)acrylic acid monomer and a polymerizable monomer containing N-alkoxymethyl amide groups or a polymerizable monomer containing different functional groups that are reactive with N-alkoxymethyl amide groups in organic solvent in the presence of
(i) a (meth)acrylic copolymer that is insoluble in water and which contains N-alkoxymethyl amide groups or different functional groups that are reactive with N-alkoxymethyl amide groups wherein either or both the mixture of monomers in (a) and/or the (meth)acrylic copolymer of (i) contains N-alkoxymethyl groups that are reactive with each other or with the different functional groups to form an acid group-containing grafted (meth)acrylic copolymer;
b. neutralizing the acid group-containing grafted (meth)acrylic copolymer;
c. dispersing the neutralized copolymer of (b) in water; and
d. polymerizing a mixture of (meth)acrylic monomers in the presence of the product of step (c).

9. A coating comprising the (meth)acrylic copolymer dispersion of claim 1.

10. A substrate coated at least in part with the coating of claim 9.

11. The substrate of claim 10, wherein the substrate is a metal can.

12. The substrate of claim 11, wherein the metal can is a food can.

13. A coating comprising the latex of claim 7.

14. A substrate coated at least in part with the coating of claim 13.

15. The substrate of claim 14, wherein the substrate is a metal can.

16. The substrate of claim 15, wherein the metal can is a food can.

17. The coating of claim 13, wherein the latex has a Tg of 60° C. to 90° C. and further comprises a phenolic crosslinker.

18. The coating of claim 17, wherein the crosslinker comprises 50 weight percent or less of the coating composition with weight percent based on total solids weight.
